(19) United States
(12) Patent Application Publication
(10) Pub. No.: US 2026/0000982 A1
(43) Pub. Date: Jan. 1, 2026

(54) GAME DEVICE AND PROGRAM

(71) Applicant: BANDAI CO., LTD., Tokyo (JP)

(72) Inventors: Daisuke SAKAMOTO, Tokyo (JP); Yuri OKAMOTO, Tokyo (JP); Atsushi YASHIKI, Tokyo (JP)

(21) Appl. No.: 19/246,360

(22) Filed: Jun. 23, 2025

(30) Foreign Application Priority Data
Jun. 28, 2024 (JP) 2024-105700

(51) Int. Cl. A63F 13/537

(52) U.S. Cl. CPC A63F 13/537

(57) ABSTRACT

A game apparatus executes a game, and the game apparatus includes: an acquisition unit that acquires character string information related to acquisition of a game element; an identification unit that identifies the game element from the character string information; a display control unit that causes a display unit to display one or more pieces of the character string information acquired by the acquisition unit in a selectable state; and a control unit that performs control such that the game element identified from the selected character string information is brought into an acquisition state in the game on a basis of selection of one of the one or more pieces of the character string information.

### CROSS-REFERENCE TO RELATED APPLICATION

This application claims priority to Japanese Patent Application No. 2024-105700, filed on Jun. 28, 2024, the entire contents of which are incorporated herein by reference.

### BACKGROUND OF THE INVENTION

### Technical Field

The present invention relates to a game apparatus and a program, and more particularly to an electronic game that provides an entertainment element using a communication function.

### Background

There is a game apparatus that acquires identification data (MAC address) of an access point present within a communication range, and brings game data into an acquisition state in an electronic game if a numerical value obtained by converting the identification data satisfies an acquisition condition of the game data (JP 2007-215777 A).

By the way, with the recent spread of wireless communication technology, there are a large number of access points. For this reason, in a case of a configuration in which identification data is acquired for all of the access points and calculation related to acquisition of game data is performed, the game cannot proceed until the end of the calculation, and the amusement experience of the game can be hindered. Therefore, for example, it is assumed that control is performed such that calculation related to acquisition of game data is performed after filter processing is performed in which identification data is limited to identification data of a high-order access point having high radio field intensity.

On the other hand, in a game apparatus assumed to be carried by the user as in JP 2007-215777 A, there is a certain demand for being able to provide a common amusement experience in a case where a plurality of users brings the game apparatuses. However, by the filter processing as described above being performed, the access point that is a calculation target may be different for each of the game apparatuses, and thus fairness may not be ensured. For example, acquired game data may be different between users who bring the game apparatuses, or only some users may not be able to acquire game data.

An object of the present invention is to provide a new technique for enhancing amusement.

### BRIEF SUMMARY

A game apparatus according to one aspect of the present invention is a game apparatus that executes a game, and includes: an acquisition unit that acquires character string information related to acquisition of a game element; an identification unit that identifies the game element from the character string information; a display control unit that causes a display unit to display one or more pieces of the character string information acquired by the acquisition unit in a selectable state; and a control unit that performs control such that the game element identified from the selected character string information is brought into an acquisition state in the game on a basis of selection of one of the one or more pieces of the character string information.

According to the present invention, a new technique for enhancing amusement can be provided.

### BRIEF DESCRIPTION OF THE DRAWINGS

FIG. 1 is a diagram illustrating a configuration of a game system according to an embodiment and modifications of the present invention;

FIG. 2 is a block diagram illustrating a hardware configuration of a game apparatus according to the embodiment and the modifications of the present invention;

FIG. 3 is a diagram illustrating a selection screen displayed in a case where a character facing function according to the embodiment and the modifications of the present invention is used;

FIG. 4 is a diagram illustrating a sticker provided in the character facing function according to the embodiment and the modifications of the present invention;

FIGS. 5A and 5B are diagrams illustrating an acquisition performance in the character facing function according to the embodiment and the modifications of the present invention;

FIGS. 6A and 6B are diagrams illustrating a sticker book for displaying a sticker provided in the character facing function according to the embodiment and the modifications of the present invention;

FIG. 7 is a diagram illustrating a detailed check screen of a sticker provided in the character facing function according to the embodiment and the modifications of the present invention;

FIG. 8 is a flowchart illustrating facing processing executed in the game apparatus according to the embodiment of the present invention;

FIG. 9 is a flowchart illustrating acquisition processing executed in the game apparatus according to the embodiment of the present invention; and

FIGS. 10A to 10C are diagrams illustrating a configuration of various types of information managed in the game apparatus according to the embodiment and the modifications of the present invention.

### DETAILED DESCRIPTION

### Embodiment

Hereinafter, embodiments will be described in detail with reference to the accompanying drawings. Note that the following embodiments do not limit the invention according to the claims, and all combinations of features described in the embodiments are not necessarily essential to the invention. Two or more features of a plurality of features described in the embodiments may be freely combined. Furthermore, the same or similar configurations are denoted by the same reference signs, and redundant description will be omitted.

In an embodiment described below, an example in which the present invention is applied to a game apparatus capable of executing a game for raising a character associated with a user (hereinafter, the game is referred to as a raising game) as an example of the game apparatus will be described. However, the present invention is applicable to any apparatus capable of executing an electronic game including an entertainment element for acquiring a game element.

### <<Configuration of Game System>>

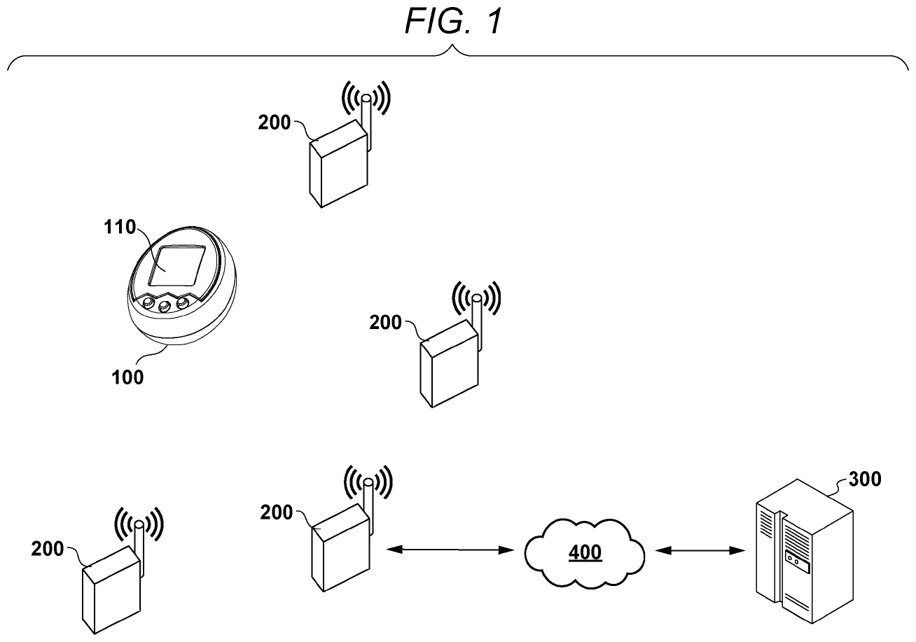

FIG. 1 illustrates a configuration of a game system according to the embodiment of the present invention. As illustrated in the drawing, in the game system, a game apparatus 100 is able to detect one or more access points (APs) 200 that exist within a communication range of the game apparatus 100. Each of the APs 200 constructs a wireless communication network of a predetermined communication method. The game apparatus 100 can participate in the wireless communication network by establishing communication connection with the AP 200, and can transmit and receive information to and from other apparatuses that participate in the wireless communication network. The game apparatus 100 can also communicate with a server 300 on a network 400 that is a wide area network (WAN) via communication connection established with the AP 200. In one aspect, the server 300 is included for distribution of update data for updating at least one of a program or data related to operation of the game apparatus 100, such as firmware of the game apparatus 100. In this aspect, the game apparatus 100 stores, for example, information for communication connection with the AP 200 included at the home of the user of the game apparatus 100, and in a case where it is confirmed that new update data exists in the server 300 at a predetermined update confirmation timing, the game apparatus 100 acquires the new update data from the server 300 via the AP 200. In a case where new update data is acquired, the game apparatus 100 updates data such as firmware currently recorded on the basis of the update data.

In the present embodiment, the game apparatus 100 is formed as a portable toy, and operates using power supplied from a battery (not illustrated). The game apparatus 100 includes a terminal (not illustrated) connectable to a power source, and is able to charge the battery by electrically connecting a commercial power source or the like to the terminal via a power supply cable.

### <Hardware Configuration of Game Apparatus>

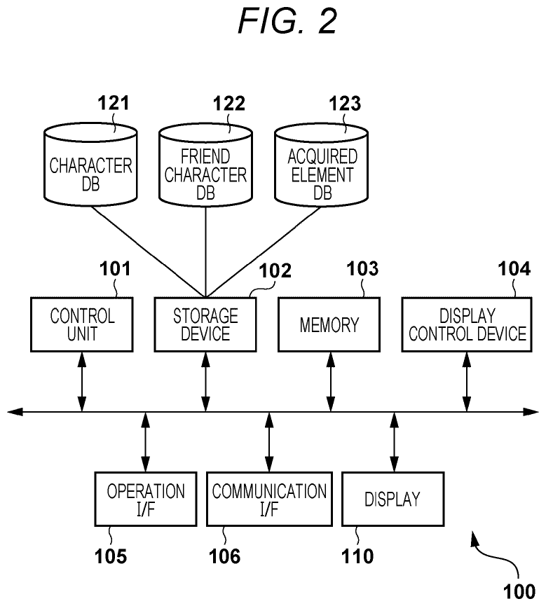

Next, a hardware configuration of the game apparatus 100 will be described with reference to FIG. 2. FIG. 2 is a block diagram illustrating a hardware configuration of the game apparatus 100.

A control unit 101 is a processor such as a central processing unit (CPU), and performs various types of control including operation control of each piece of hardware included in the game apparatus 100. Specifically, for example, the control unit 101 reads a necessary program stored in a storage device 102, deploys the program in a memory 103, and executes the program to perform corresponding control. Furthermore, the control unit 101 includes a built-in clock and is able to acquire the current time.

The storage device 102 is a device capable of storing permanent information, such as a nonvolatile memory. In addition to a program related to the operation of the game apparatus 100 and a program of a raising game executed in the game apparatus 100, the storage device 102 stores information of parameters necessary for implementing various types of control. Furthermore, the storage device 102 also functions as a database of various types of data related to the raising game (character DB 121 and friend character DB 122). The memory 103 is a storage device used for temporary data storage, such as a volatile memory. The memory 103 may be used not only as a deployment area of each program but also as a storage area for temporarily storing data or the like output in the course of operation of various types of hardware or various types of control.

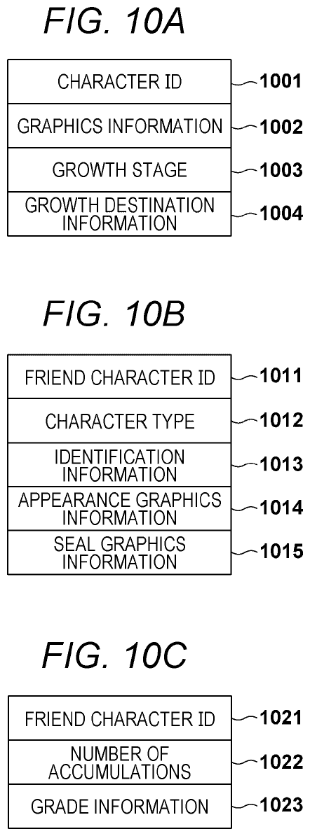

The character DB 121 is a database that manages information regarding characters that can be raised in the raising game (character information) as a record. In the raising game executed in the game apparatus 100 according to the present embodiment, the user can raise a character that grows through a plurality of growth stages. The character has a different appearance each time the growth stage changes. The character DB 121 manages various types of information as a record for each appearance that can be taken by a character at each growth stage. For example, as illustrated in FIG. 10A, character information related to one record includes, in association with a character ID 1001 that uniquely identifies (the appearance of) a character, graphics information 1002 for drawing the appearance of the character, a growth stage 1003 indicating a growth stage in which the character has the appearance, and growth destination information 1004 indicating an appearance into which the character can grow from the appearance. The growth destination information 1004 may store information of the corresponding character ID 1001.

The friend character DB 122 is a database that manages, as a record, information (friend character information) related to a character that appears in the raising game by using a character facing function to be described below (hereinafter, the character is referred to as a friend character). Details of the database will be described below together with the description of the character facing function.

Furthermore, the storage device 102 also includes an acquired element DB 123 for managing the progress status of the raising game related to the character facing function to be described below. The acquired element DB 123 is a database that manages, as a record, information (acquired element information) related to a game element that is brought into an acquisition state in the raising game by using the character facing function. Details of the database will be described below together with the description of the character facing function.

A display control device 104 performs display control such that various screens related to the raising game are displayed on a display 110. In the present embodiment, the display control device 104 includes, for example, a drawing device such as a graphics chip or a graphics processing unit (GPU), and also executes drawing processing of generating various screens related to the raising game. The display control device 104 includes a drawing memory (not illustrated), deploys various types of graphics data read from the storage device 102, and performs predetermined calculation to generate various images (screens) related to the raising game. The screen and the image generated by the display control device 104 are presented to the user by being displayed on, for example, the display 110 included in the game apparatus 100. The display 110 is a device that is included in the game apparatus 100 and displays information, such as a liquid crystal display.

An operation I/F 105 is a user interface that is included in the game apparatus 100 and receives an operation input. In a case where it is detected that an operation input has been made, the operation I/F 105 outputs a control signal corresponding to the operation input to the control unit 101. In one aspect, the operation I/F 105 includes, for example, operation members such as buttons included on the exterior of the game apparatus 100, various sensors, and the like. In an aspect in which the display 110 is able to detect a touch input, the operation I/F 105 includes a touch input detection sensor included in the display 110.

A communication I/F 106 is an interface included in the game apparatus 100 for communication with an external device. As described above, the game apparatus 100 according to the present embodiment is able to detect the AP 200 within a communication range.

### <<Outline of Game>>

Hereinafter, an outline of a game in which a play experience is provided in the game apparatus 100 according to the present embodiment will be described. In the present embodiment, the game will be described as a raising game that provides a raising element of a character, a communication element between a user and a character, and an interaction element between characters as entertainment elements. However, the raising game is merely one aspect of a game in which a character appears, and implementation of the present invention is not limited thereto. The present invention is applicable to any game in which a character whose motion is controlled in accordance with an operation input performed by a user appears. Here, the motion control is not limited to a case where the user directly operates a character, and includes a case where an action or a motion of the character indirectly changes in response to a change in a parameter or an environment as a result of evaluation of an operation input performed by the user.

In the raising game, the user can raise a character by performing an operation input related to care for the character. The raising game starts from hatching of an egg, for example, and presents that a growth stage progresses by necessary operation inputs related to care being sequentially performed and the character grows while changing the appearance.

Here, the character in each growth stage has an appearance determined in advance for the growth stage. In other words, in the raising game of the present embodiment, the appearance that can be taken by the character in each growth stage is determined in advance, and for example, it is determined which appearance the character is grown into according to the selected egg or the state of care in the growth stage so far. As described above, the appearance of the character is determined as the graphics information 1002 in the character information registered in the character DB 121.

Hereinafter, a character to be raised by the user in the raising game executed in the game apparatus 100 will be referred to as a “raised character”.

### <<Character Facing Function>>

In the raising game of the present embodiment, the “character facing function” is set up as one of functions for providing an entertainment element in which the raised character interacts with another character. By using the character facing function, the user can search for a friend character and generate an event (facing event) in which the raised character faces the friend character found by the search. In the present embodiment, the friend character is a non-player character (NPC) whose appearance and the like are determined in advance, and the user can experience the facing event using the character facing function at any time. Furthermore, in the raising game, a plurality of characters is set up as friend characters, and for example, a facing event of facing one of the friend characters occurs using the character facing function one time.

In the raising game, for each of the friend characters, the degree of intimacy with the raised character is managed as a parameter. Basically, the degree of intimacy increases in accordance with the number of times the raised character has faced the friend character, that is, the number of times a facing event related to the same friend character has occurred. In other words, the user can increase the degree of intimacy between the friend character and the raised character by experiencing the facing event of facing the same friend character a plurality of times.

The degree of intimacy related to a friend character is increased by degree-of-intimacy points that are one of game elements provided in a facing event being accumulated. In the raising game of the present embodiment, in a case where a facing event occurs, basically one degree-of-intimacy point is provided for a friend character faced in the facing event, and the degree-of-intimacy point is brought into the acquisition state in the raising game. Thereafter, each time a facing event of facing the same friend character occurs, the degree-of-intimacy point related to the friend character is provided one by one, and thus the degree-of-intimacy point that has been brought into the acquisition state is accumulated and the total number thereof increases.

In the present embodiment, it is assumed that one degree-of-intimacy point increases the degree of intimacy by one, and the degree of intimacy also increases by one every time the number of accumulations increases by one. In an aspect in which the upper limit number is determined for the degree of intimacy, the number of accumulable degree-of-intimacy points is also set up correspondingly. In the following description, it is assumed that the upper limit number of the degree of intimacy is set to five, and the number of accumulable degree-of-intimacy points is also set to five. Here, in a case where the number of the accumulated degree-of-intimacy points related to one friend character has already reached five and a facing event related to the friend character occurs thereafter, control is performed such that a degree-of-intimacy point is not provided, or even if a degree-of-intimacy point is provided, the degree-of-intimacy point is not brought into the acquisition state and is not accumulated.

Furthermore, in the facing event, in addition to degree-of-intimacy points related to a faced friend character, a sticker or seal related to the friend character is also provided as another game element. The sticker is, for example, a game element including an image element indicating the appearance of the corresponding friend character, and the user can browse a sticker that is brought into the acquisition state in the raising game at a desired timing in a sticker book to be described below.

In the raising game of the present embodiment, the sticker related to one friend character is different from degree-of-intimacy points, and is provided only in a case where the number of accumulated degree-of-intimacy points, that is, the degree of intimacy satisfies a predetermined condition. In the following description, in a case where the degree of intimacy reaches one, three, and five due to a degree-of-intimacy point that is brought into the acquisition state for a friend character faced in a facing event, it is assumed that a sticker related to the friend character is further provided in the facing event and is brought into the acquisition state in the raising game.

Although details will be described below, it is assumed that an available sticker for one friend character is different in each of the three acquisition opportunities. In the raising game of the present embodiment, after acquiring the sticker related to one friend character, the sticker is further updated to a sticker having a high grade (may define a value in the raising game, such as class and rarity) by acquiring a sticker related to the friend character. That is, regarding the sticker related to a friend character, a sticker having a higher grade is brought into the acquisition state as the degree of intimacy increases due to a facing event.

Therefore, in the raising game executed in the game apparatus 100 according to the present embodiment, by using the character facing function, a degree-of-intimacy point or a degree-of-intimacy point and a sticker related to any friend character are brought into the acquisition state due to a facing event that occurs. In other words, during execution of processing related to a facing event, acquisition processing for bringing these game elements into the acquisition state of a user or a raised character is executed, and information related to the raising game is updated.

Such basic information regarding a friend character is managed using the friend character DB 122 in the game apparatus 100 according to the present embodiment. As described above, in one record of the friend character DB 122, information regarding one friend character is managed as the friend character information. For example, as illustrated in FIG. 10B, the friend character information related to one record includes, in association with a friend character ID 1011 that uniquely identifies a friend character, a character type 1012 indicating the type of the friend character, identification information 1013 that describes information for identifying the friend character as a friend character to be faced in a facing event, appearance graphics information 1014 for drawing the appearance of the friend character, and sticker graphics information 1015 for drawing a sticker of the friend character.

Furthermore, the acquisition processing is executed along with occurrence of a facing event, so that information regarding a game element that is brought into the acquisition state in the raising game is managed using the acquired element DB 123. In one record of the acquired element DB 123, information regarding a game element acquired for one piece of the friend character information is managed as acquired element information. As illustrated in FIG. 10C, for example, the acquired element information related to one record includes, in association with a friend character ID 1021 that uniquely identifies a friend character, the number of accumulations 1022 of the degree-of-intimacy points accumulated for the friend character and grade information 1023 indicating the grade of an acquired sticker (highest grade of acquired stickers) for the friend character. Therefore, by the acquisition processing being executed with occurrence of a facing event, a record of new acquired element information is generated and registered for a friend character faced for the first time. Furthermore, for a friend character faced in the past, the number of accumulations 1022 or the number of accumulations 1022 and the grade information 1023 of the acquired element information related to the friend character already registered are updated.

Since addition of a record to the acquired element DB 123 is different for each user according to the progress of the raising game, more specifically, a facing event generated using the character facing function, the acquired element DB 123 may be a database in which there is no record in the initial state. Note that, in the present embodiment, the description will be given assuming that information management of a game element that is brought into the acquisition state by using the character facing function is performed using the database (acquired element DB 123) for convenience, but implementation of the present invention is not limited thereto. For the information management, for example, various methods including addition of an entry to a table included in the storage device 102 can be adopted.

### <Identification of Friend Character to be Faced>

In order to increase the randomness and the amusement of a facing event, a friend character discovered in a search related to the use of the character facing function changes depending on the position of the game apparatus 100 and the environment in which the game apparatus 100 exists. In the present embodiment, the AP 200 that exists around the game apparatus 100 is detected, and a friend character to be faced by using the character facing function is identified on the basis of information acquired from the AP 200.

Each AP 200 broadcasts a beacon signal so as to make the AP 200 detectable. The beacon signal includes at least an identifier for identifying the AP 200, and in the raising game of the present embodiment, the identifier is used for searching for a friend character in the character facing function.

Hereinafter, the beacon signal will be referred to as AP information. The AP information includes at least a basic service set identifier (BSSID) as first character string information and an extended service set identifier (ESSID) as second character string information according to the present invention as the identifier of the transmission source AP 200. Here, the ESSID is composed of half-width alphanumeric characters of up to 32 characters, while the BSSID is a 48 bit numerical value, and both of them will be described as “character string information” in the present specification since the BSSID is expressed using 0 to 9 and half-width alphanumeric characters of A to F in hexadecimal notation or the like.

That is, in a case where the character facing function is used, the AP information is acquired from the AP 200 that exists around the game apparatus 100, and a friend character identified on the basis of the character string information (BSSID or ESSID) included in the AP information is treated as being found by a search. In the raising game of the present embodiment, there are two types of friend characters, and a type of a friend character to be found changes according to the acquired AP information. Hereinafter, the type of a friend character will be described.

### (Normal Character)

The first type is a normal character. A predetermined number of normal characters are set up in advance, and one of them is identified on the basis of the AP information. In the present embodiment, it is assumed that a normal character is identified on the basis of a value of a solution obtained by performing a predetermined calculation on a value corresponding to the BSSID in the AP information so that the normal character can be faced without depending on the presence of a specific AP 200. For example, in an aspect in which 30 friend characters are set up as normal characters, each of the normal characters is assigned a numerical value of 0 to 29 without overlap, and in the predetermined calculation, the solution is any integer in a value range of 0 to 29. That is, a friend character identified as a normal character by the AP information is a friend character associated with the same value as the value of the solution obtained by performing the predetermined calculation on the BSSID in the AP information.

Here, the use of the BSSID for identifying a normal character is, in one aspect, for equalizing a facing condition for each of the predetermined number of the normal characters. Since the ESSID can designate a character string including any number of characters by the installer of the AP 200, there may be a difference in the facing condition between the normal characters in a case where the ESSID is used for calculation. In the case of the BSSID, the BSSID is fixed to 48 bits, and can be treated as a 48 digit numerical value in binary digits and a 12 digit numerical value (character string) in hexadecimal digits, and thus at least the influence of the bias of the facing condition due to a difference in the number of characters as in the ESSID can be excluded.

Therefore, in the friend character information managed in the friend character DB 122 for a normal character, information regarding a value derived as a result of the predetermined calculation (value assigned to a friend character) is stored in the identification information 1013. More specifically, in the identification information 1013 of the friend character information indicating that the character type 1012 is a normal character, any value obtained by performing the predetermined calculation on the BSSID is stored.

With such a configuration, each of the normal characters is not limited to the specific AP 200, and can be faced regardless of the position or environment of the game apparatus 100 as long as the BSSID of the detected AP 200 satisfies a predetermined condition.

### (Special Character)

The second type is a special character. Unlike normal characters, a special character is able to be faced only in a case where a specific AP 200 is detected. For example, a special character may be set so as to be identifiable only on the basis of AP information acquired from the AP 200 set up in an event venue of a specific event. In the present embodiment, in a case where the ESSID in the AP information indicates a specific character string, a special character associated with the ESSID can be faced. In other words, each special character is associated with a unique ESSID (hereinafter, may be referred to as a special SSID), and the corresponding special character is identified on the basis of the AP information only in a case where the acquired AP information includes the ESSID.

Here, the use of the ESSID for identifying a special character depends on the BSSID being assigned to each wireless communication network and the same BSSID being able to be adopted in a plurality of wireless communication networks.

The information of the ESSID related to a special character may be stored in the identification information 1013 of the friend character information managed in the friend character DB 122 for the special character. That is, a special SSID set for a special character is stored in the identification information 1013 of the friend character information indicating that the character type 1012 is the special character.

Here, assuming a use form in which a special character can be faced only in an event venue for the purpose of attending an event, occurrence of a facing event related to the special character is preferably limited to a specific period such as a holding period of the event. That is, the facing event related to the special character preferably does not occur outside the specific period. Therefore, the special SSID may be stored in the identification information 1013 of the friend character information related to the special character in a limited period of time.

Such control can be performed using, for example, an update function of acquiring update data from the server 300 and updating the game apparatus 100. Specifically, for example, information of the special SSID related to the special character may be included in the update data delivered immediately before the start date of the event or the like, and update based on the update data may be performed so as to update the identification information 1013 of the friend character information related to the special character. As described above, in order to attend an event and generate a facing event related to a special character, update of the firmware or the like of the game apparatus 100 is required, so that the user can be promoted to update the main body and provision of a favorable entertainment experience can be ensured. Note that, in this aspect, for example, the identification information 1013 of the friend character information related to a special character may be updated so that the information of the special SSID related to the special character limited to the event is deleted by update data delivered immediately after the end date of the event or the like.

### <Facing Event Selection>

Meanwhile, depending on the environment in which the game apparatus 100 exists, a plurality of APs 200 may exist in the surroundings, and a plurality of pieces of AP information is also acquired at the time of detection. In the character facing function of the present embodiment, in a case where a plurality of APs 200 is detected and a facing event is generated for all the APs, the user cannot use other functions, and thus, by the user being allowed to select AP information acquired related to any one of the APs 200, a friend character to be faced through the facing event is limited.

Therefore, in the character facing function, after the surrounding APs 200 are detected, the display 110 is caused to display the ESSIDs of the acquired one or more pieces of AP information, and the user is caused to select one of the ESSIDs. Then, in a case where an operation input (selection operation) for selecting an ESSID is made, a facing event of facing a friend character identified by the corresponding AP information is generated. That is, in the game apparatus 100 according to the present embodiment, in a case where the use of the character facing function is started, detection of the surrounding APs 200 is performed and one or more pieces of AP information are acquired, and a selection operation of the user is accepted as to which of the pieces of AP information a facing event is to be generated on the basis of.

Here, the reason why character string information displayed in a selectable manner is set as the ESSIDs included in AP information is that, in general, there is a tendency that a character string that is easy for a human to recognize/memorize is set in the ESSIDs by installers or the like of the APs 200. As described above, since degree-of-intimacy points related to a friend character are provided on condition that a facing event related to the friend character occurs, the acquired AP information is displayed in a selectable manner using the ESSIDs, so that the user can easily select AP information that has been selected in the past, and as a result, the degree of intimacy related to the desired friend character can be easily increased.

On the other hand, a BSSID is basically automatically determined for the wireless communication network, and may not be a character string that is easy for humans to memorize. Therefore, in the character facing function of the present embodiment, control is performed such that the BSSIDs of the acquired AP information are not displayed on the display 110.

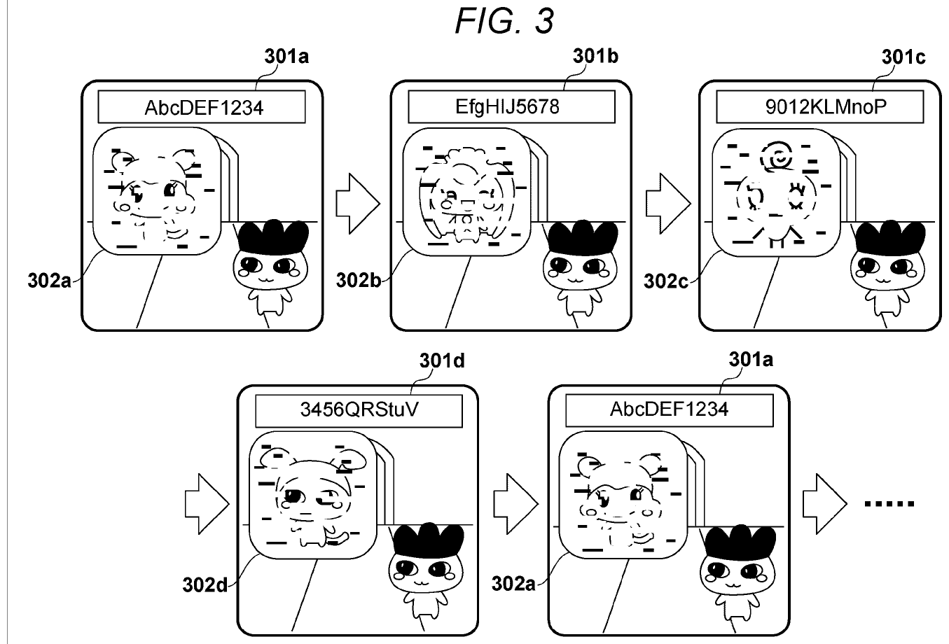

FIG. 3 illustrates a transition example of a screen displayed on the display 110 in a case where a selection operation of AP information (ESSID) for generating a facing event is received (hereinafter, the screen is referred to as a selection screen). In the aspect in which the game apparatus 100 is formed as a portable toy as illustrated in FIG. 1, the number of characters that can be displayed on the display 110 with a distinguishable character size is limited. Therefore, in the example of FIG. 3, the number of ESSIDs (301 [a to d]) temporarily displayed on the selection screen is one, and different ESSIDs are sequentially displayed in response to an operation input related to a screen feed operation.

In a case where ESSIDs are selectively displayed one by one on the selection screen in the mode as illustrated in FIG. 3, an operation required until the user selects a desired ESSID may be complicated depending on the number of pieces of acquired AP information. Therefore, in the game apparatus 100 according to the present embodiment, for example, a maximum of four pieces of AP information are extracted from the top of the signal strength of received beacon signals (AP information), and the ESSIDs included in the AP information are displayed on the selection screen as selection targets for occurrence of a facing event. In the transition example of the selection screen illustrated in FIG. 3, a maximum of four pieces of AP information are extracted, and the ESSIDs are displayed as selection targets.

However, what type of friend character the AP information is associated with is determined by the manufacturer or the like of the game apparatus 100, and it is difficult for the user to identify the friend character at a glance. On the other hand, in a specification in which the degree of intimacy increases according to the number of times of occurrence of a facing event and a high-grade sticker can be acquired, it is assumed that the user desires occurrence of a facing event related to a friend character that the user has already faced or a facing event related to a friend character that the user has not faced yet. Therefore, in the game apparatus 100 according to the present embodiment, for ESSIDs displayed on the selection screen, images (302 [a to d]) suggesting friend characters identified by AP information including the ESSIDs are displayed in association with the ESSIDs. For example, as illustrated in FIG. 3, the suggesting images can display at least a part of the appearance of a friend character, such as a silhouette of the friend character or a part of a decorative article, in an unclear manner.

By the way, in a mode of extracting up to a predetermined number of pieces of AP information of higher signal strength and displaying the AP information on the selection screen, AP information related to a desired AP 200 may not be included in the options. As described above, since the facing opportunity is set to be limited for a special character as compared with the normal characters, for example, a situation is inconvenient for the user in which even if the user uses the character facing function at an event venue and receives AP information related to a special character, an option related to the AP information is not displayed on the selection screen.

Therefore, in the character facing function of the present embodiment, in a case where AP information including a valid special SSID is acquired, a facing event of facing a special character related to the AP information is forcibly generated. That is, in a case where the AP information related to a special character is acquired, a facing event related to the special character occurs without a selection operation via the selection screen as illustrated in FIG. 3 accepted, and a game element (degree-of-intimacy point and sticker) related to the special character is brought into the acquisition state. Therefore, the selection screen as illustrated in FIG. 3 is displayed in order to generate a facing event related to a normal character in the character facing function of the present embodiment.

Note that, if a facing event related to a special character is forcibly generated in a case where AP information related to the special character is acquired, a facing event related to another friend character cannot be generated unless the user moves the game apparatus 100 to a position where the AP information is not received. Therefore, occurrence of a facing event related to a special character is limited to once a day, for example. That is, in a case where AP information including a valid special SSID is included in acquired AP information, control is performed such that a facing event related to a special character occurs on condition that a degree-of-intimacy point related to the corresponding special character is not brought into the acquisition state on the same day. Such control can be implemented, for example, by storing logical type information indicating whether a facing event has occurred on the day for each special SSID registered as currently valid in the memory 103 or the like and referring to the information.

Therefore, in a case where acquired AP information does not include AP information including a valid special SSID, or in a case where a facing event related to the special SSID has already occurred on the same day even if the acquired AP information includes the valid special SSID, the selection screen as illustrated in FIG. 3 is displayed on the display 110. At this point, even if the AP information including the valid special SSID is included in the upper predetermined number of pieces of AP information based on the signal strength, the AP information is excluded from the display target. This is because, for example, a game element related to a special character is preferably available only to visitors of an event, and an occurrence condition of a facing event related to the special character is widely known by the game element being displayed together with an image suggesting a special SSID related to the special character. Then, in a case where a selection operation of an ESSID for which a facing event is generated is received via the selection screen, a normal character is identified on the basis of the BSSID of AP information including the selected ESSID, and control is performed such that a facing event related to the normal character occurs.

### <Sticker Provision>

Hereinafter, a sticker related to a friend character that is brought into the acquisition state by execution of the acquisition processing in a case where a facing event occurs will be described in detail.

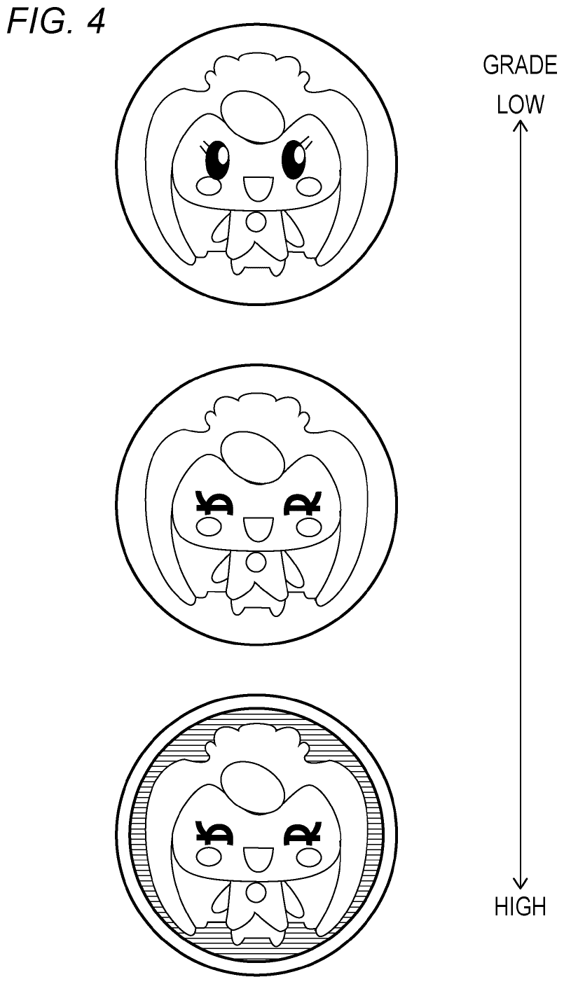

As described above, in the character facing function according to the present embodiment, the upper limit of the degree of intimacy is set to five, and control is performed such that a sticker related to a faced friend character is provided in a case where the degree of intimacy reaches one, three, and five in a facing event. At this time, in order to demonstrate that the sticker is a proof of the degree of intimacy, a higher grade sticker is provided as the degree of intimacy increases. For example, as illustrated in FIG. 4, the difference in the grade may be expressed by changing the color of the sticker or the graphic of the expression of a friend character that appears in the sticker.

As described above, a configuration in which stickers of high grade are sequentially available by a plurality of times of facing is useful from the viewpoint of improving the amusement of sticker collection. However, AP information in which the same normal character is identified can be easily acquired from the AP 200 with which the game apparatus 100 mainly communicates, such as an access point set up at home. In such an environment, the sticker related to a normal character corresponding to the AP 200 can be easily acquired by the ESSID related to the AP 200 being repeatedly selected, and the amusement related to sticker collection can be reduced. For this reason, in the character facing function of the present embodiment, provision of a degree-of-intimacy point related to the same normal character is temporally limited.

The temporal limitation may be to perform limiting such that, for example, the provision of a degree-of-intimacy point related to the same normal character is limited to once a day, and a degree-of-intimacy point is further provided on condition that the date has changed. In other words, for one normal character, a degree-of-intimacy point or a degree-of-intimacy point and a sticker related to the normal character can be brought into the acquisition state again on condition that the date is different from the date on which a degree-of-intimacy point is most recently brought into the acquisition state. In this aspect, the user needs to use the character facing function in the communication range of the AP 200 that provides AP information including a BSSID for identifying one normal character separately for five days until the user acquires a sticker of the highest grade for the normal character.

On the other hand, since the facing opportunity is set to be limited for a special character as compared with the normal characters, it may be harsh for the user to set a sticker provision condition for a special character similar to that for normal characters. For example, in an aspect in which AP information related to a predetermined special character is provided by the AP 200 installed in an event venue or the like, in a case where the sticker provision condition is similar to that of normal characters, the user needs to go to the event venue separately for five days in order to acquire a sticker of the highest grade related to the special character.

For this reason, in the character facing function of the present embodiment, provision conditions of a degree-of-intimacy point and a sticker are determined differently between normal characters and special characters. More specifically, for a special character, the upper limit degree-of-intimacy points are provided at the first facing. Furthermore, since the degree of intimacy is maximized by the provision, a sticker of the highest grade is also provided. That is, in the character facing function of the present embodiment, in a case where AP information including a special SSID is received, a degree-of-intimacy point related to a special character associated with the special SSID is brought into the acquisition state by execution of the acquisition processing, whereby the degree of intimacy is maximized, and on the basis of this, control is performed such that a sticker of the highest grade is brought into the acquisition state.

Therefore, for a special character, image data related to a sticker may be prepared only for one grade (highest grade). That is, a normal character has a larger number of grades provided for a sticker than a special character.

### <Acquisition Performance>

In order to increase the amusement of the character facing function, in the acquisition processing, a performance (acquisition performance) is displayed in which a friend character (target character) based on AP information faces a raised character or a game element brought into the acquisition state is presented.

In the acquisition performance, the content changes according to the degree of intimacy updated by execution of the acquisition processing. In one aspect, the change in the content of the acquisition performance may be expressed by a change in a scene where a raised character and a target character face each other. The background of the performance may be changed such that a change in the sense of distance between characters is presented according to the degree of intimacy, and for example, the background may be a park for the first time, a shopping mall for the second time, an amusement facility for the third time, and a room of the target character for the fourth and fifth times.

As described above, since the change mode of the degree of intimacy is different between normal characters and special characters, the content change of the acquisition performance may be performed only in the case of normal characters. That is, in the character facing function of the present embodiment, the degree of intimacy of a special character reaches the upper limit value at the time of execution of the first acquisition processing, and thus, the content of the acquisition performance related to special characters can be fixed. Here, the acquisition performance related to special characters may have a content similar to the acquisition performance related to normal characters in a case where the degree of intimacy is five, or may have a unique content formed for special characters.

Furthermore, the acquisition performance may include a performance indicating that the degree of intimacy of a faced character increases (by a degree-of-intimacy point being brought into the acquisition state), and a performance in which a sticker is provided in a case where the degree of intimacy satisfies the sticker provision condition (in a case where the degree of intimacy is one, three, or five).

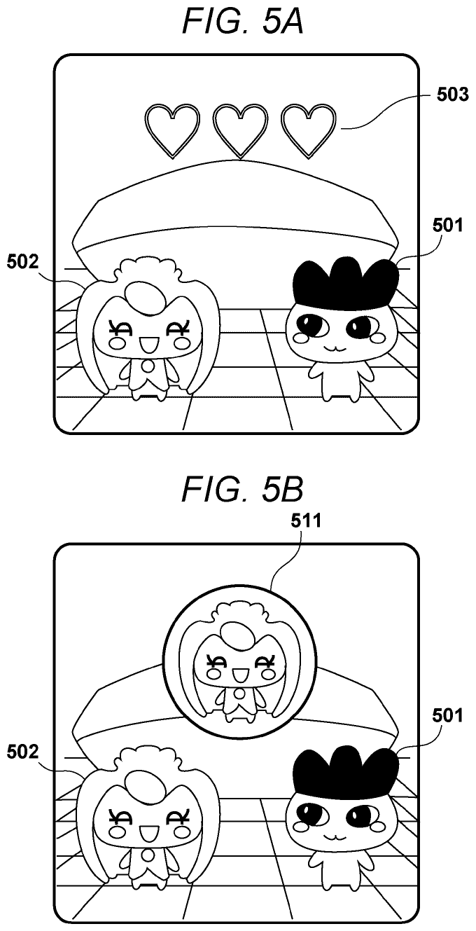

FIGS. 5A and 5B illustrates a display example related to an acquisition performance in a case where the degree of intimacy reaches three.

As illustrated in FIG. 5A, in the acquisition performance, since one degree-of-intimacy point is newly brought into the acquisition state and the number of accumulated points is three, it is illustrated that a raised character 501 and a normal character 502 face each other in a scene with an amusement facility (baseball park in the example of the figure) corresponding to the degree of intimacy of three as a background. FIG. 5A also includes degree-of-intimacy display 503 indicating the number of accumulated points of degree-of-intimacy points after the acquisition processing. In the example of the figure, the degree-of-intimacy display 503 indicates one degree-of-intimacy point by a heart image element, and three image elements corresponding to the number of accumulations after acquisition are disposed. Since the degree-of-intimacy display 503 indicates that a change has occurred in the number of accumulations, for example, a time transition in which one image element is added to two image elements and the image elements are changed to three image elements can be displayed.

Furthermore, after the number of accumulated degree-of-intimacy points after the acquisition processing is displayed in FIG. 5A, as illustrated in FIG. 5B, the acquisition performance proceeds so that it is presented that a sticker that is associated with the degree of intimacy of three and of which the provision condition is satisfied is brought into the acquisition state. In FIG. 5B, acquired sticker display 511 indicating that a sticker of a normal character associated with the degree of intimacy of three is brought into the acquisition state is displayed.

In such an acquisition performance, display may be started at the following timing. An acquisition performance related to a normal character is started on the basis of a selection operation on one of one or more ESSIDs on the selection screen. On the other hand, the acquisition performance related to a special character is started in a case where the acquisition period of AP information ends and it is determined that AP information including a special SSID exists in one or more pieces of the acquired AP information. In any acquisition performance, acquisition processing is executed prior to the display, and the content reflecting provision of a game element by using the current character facing function is controlled.

For example, in a case where an ESSID related to a normal character for which a new degree-of-intimacy point is already in the acquisition state on the day is selected on the selection screen, a new game element is not brought into the acquisition state in the acquisition performance related to the normal character. Therefore, control may be performed such that a state is displayed in which only the raised character and the normal character face each other as the acquisition performance without the degree-of-intimacy display 503 and the acquired sticker display 511 illustrated in FIGS. 5A and 5B.

### <Sticker Book>

The sticker acquired by the character facing function as described above is browsable in the sticker book. For example, the sticker book may be displayable in response to an operation input for selecting a dedicated menu associated with the character facing function.

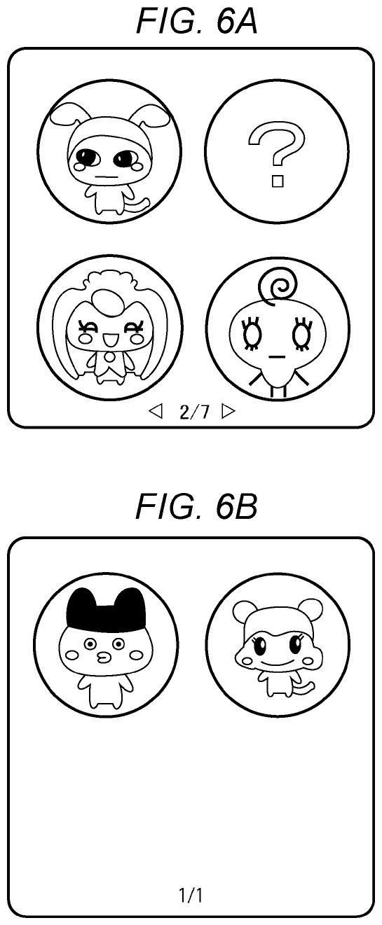

In the game apparatus 100 of the present embodiment, the sticker book is separately included for each of normal characters and special characters. That is, the sticker book includes a sticker book for normal characters and a sticker book for special characters, and the user can transition display to a sticker book screen by performing an operation input of further selecting to browse any sticker book. As illustrated in FIGS. 6A and 6B, on each sticker book screen, a list of stickers in the acquisition state is displayed over a plurality of pages as necessary.

FIG. 6A illustrates the sticker book screen for normal characters. In the sticker book screen for normal characters, a fixed arrangement position (page and display position) is assigned to a sticker related to each of the normal characters. As illustrated, in a case where a sticker has been acquired for one normal character, the acquired sticker is arranged and displayed at the arrangement position assigned to the normal character. Here, the sticker to be arranged may be a sticker of the grade that has been most recently provided (that is, a sticker of the highest grade) among stickers already acquired for the normal character. For example, in a case where the degree of intimacy of one normal character is four, the sticker displayed in the sticker book for the normal character is a sticker that is brought into the acquisition state in a case where the degree of intimacy reaches three.

Furthermore, in a case where a sticker has not been acquired for one normal character, a sticker to be displayed at an arrangement position (column) assigned to the normal character is displayed in an unidentifiable manner at the arrangement position. In the example of FIG. 6A, at an arrangement position of a normal character for which a sticker has not been acquired, an image element including a “?” mark is displayed in a round frame of a form of the sticker. In this way, the user can be notified that there is a normal character for which a sticker has not been acquired through the sticker book for normal characters.

On the other hand, the facing opportunity is set to be limited for special characters as compared with normal characters, and there may be a special character for which the user cannot acquire a sticker even if the user desires. For example, the facing condition cannot be satisfied in a case where the period in which a special character can be faced has passed. It is hard for the user to know the presence of such a sticker in the sticker book. Therefore, in the sticker book screen for special characters, an arrangement position for a sticker is not included for special characters for which the sticker has not been acquired, and as a result, as illustrated in FIG. 6B, stickers related to special characters are arranged from the head. The example of FIG. 6B illustrates the sticker book screen for special characters in a case where there are two special characters for which stickers are in the acquisition state, and no sticker is arranged in the lower half area of the screen.

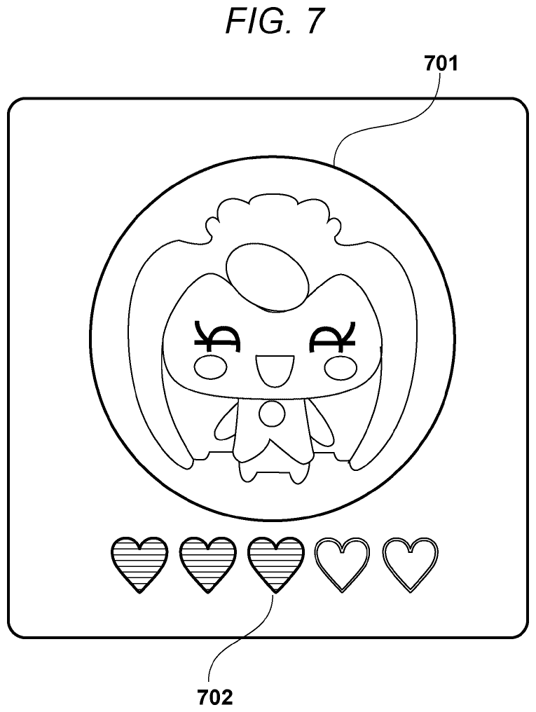

Furthermore, on the sticker book screen, a selection operation for a sticker in the acquisition state can be received. By performing a selection operation for selecting any sticker in the list, the user can shift display of the display 110 to a detail check screen related to the sticker. On the detail check screen, for example, as illustrated in FIG. 7, a sticker 701 for which the selection operation has been performed is displayed in a size larger than that of the sticker book screen, and the details can be checked. In the example of the figure, in addition to the enlarged sticker 701, a degree-of-intimacy gauge 702 indicating the degree of intimacy of a friend character related to the sticker is also arranged on the detail check screen.

The degree-of-intimacy gauge 702 indicates the number of accumulated degree-of-intimacy points provided by execution of the acquisition processing for the corresponding friend character, that is, the degree of intimacy. In the example of the figure, the degree-of-intimacy gauge 702 is illustrated with five heart-shaped vessels, and indicates the degree of intimacy for the corresponding friend character depending on how many vessels are filled. In the character facing function of the present embodiment, since the upper limit of the degree of intimacy related to each friend character is set to five, one vessel of the degree-of-intimacy gauge 702 illustrated in FIG. 7 corresponds to the degree of intimacy of one. That is, the number of vessels filled in the degree-of-intimacy gauge 702 indicates the degree of intimacy (number of accumulated degree-of-intimacy points). Furthermore, the number of vessels not filled in the degree-of-intimacy gauge 702 indicates how many more degree-of-intimacy points are available for the corresponding friend character, in other words, how many more facing events of facing the friend character need to occur before a sticker of the highest grade is acquired.

### <<Facing Processing>>

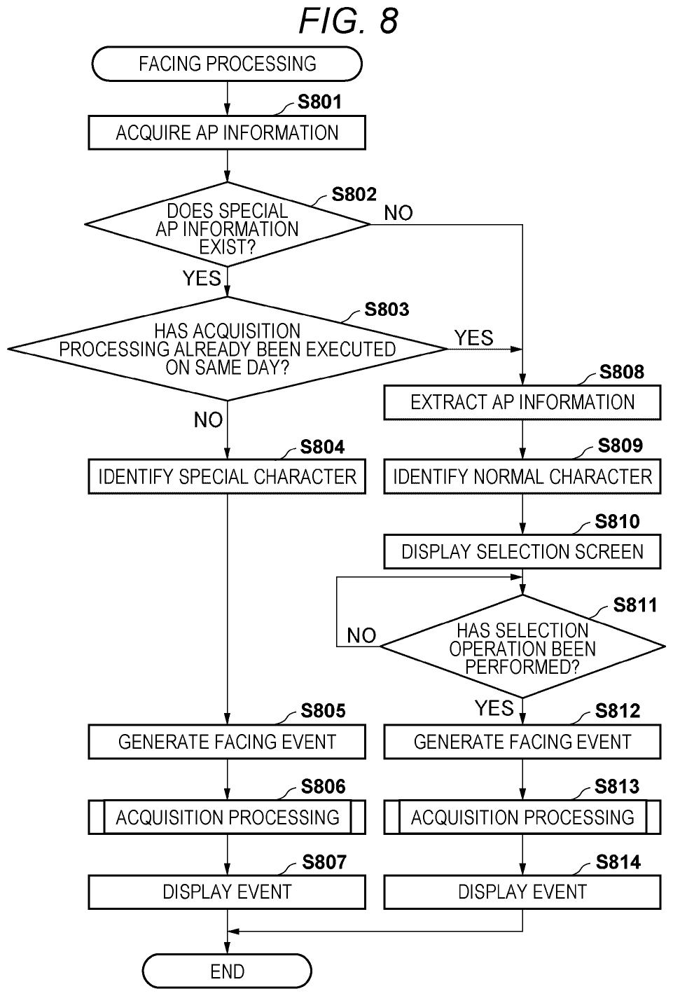

Hereinafter, specific processing of facing processing executed according to the character facing function in the game apparatus 100 of the present embodiment will be described with reference to the flowchart of FIG. 8. The processing corresponding to the flowchart can be implemented by the control unit 101, for example, reading a corresponding processing program stored in the storage device 102, deploying the processing program in the memory 103, and executing the processing program. Note that the present facing processing will be described as being started, for example, in a case where an operation input related to use of the character facing function is detected.

In S801, the control unit 101 acquires one or more pieces of AP information by receiving a beacon signal broadcast by the surrounding APs 200. The processing of this step is performed until a predetermined detection time elapses, and after the detection time elapses, the control unit 101 is required to shift the processing to S802.

In S802, the control unit 101 determines whether AP information including a valid special SSID (hereinafter, referred to as special AP information) exists in the one or more pieces of AP information acquired in S801. If it is determined that the special AP information exists in the acquired AP information, the control unit 101 shifts the processing to S803, and if it is determined that the special AP information does not exist, the control unit 101 shifts the processing to S808.

In S803, the control unit 101 determines whether the acquisition processing has already been executed for the special AP information on the same day. Note that determination related to the time range may be performed depending on the time setting set for the game apparatus 100. If the control unit 101 determines that the acquisition processing has already been executed on the same day for the special AP information, the processing proceeds to S808, and if the control unit 101 determines that the acquisition processing has not been executed, the processing proceeds to S804.

In S804, the control unit 101 identifies a special character corresponding to the special AP information. Specifically, the control unit 101 identifies friend character information including an ESSID in the identification information 1013 from the friend character DB 122 on the basis of the ESSID included in the special AP information, and identifies a special character on the basis of the friend character information.

In S805, the control unit 101 generates a facing event related to the special character identified in S804.

In S806, the control unit 101 executes the acquisition processing of providing a game element to the special character identified in S804 to bring the game element into the acquisition state.

### <Acquisition Processing>

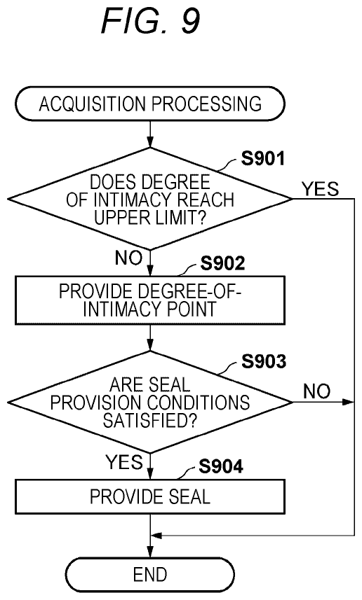

Here, the acquisition processing executed in this step will be described in detail with reference to the flowchart of FIG. 9. Note that, in the description of this acquisition processing, a friend character to be processed will be referred to as a target character.

In S901, the control unit 101 determines whether the degree of intimacy of the target character reaches the upper limit. The determination in this step can be made by referring to the number of accumulations 1022 of the acquired element information related to the target character. If the control unit 101 determines that the degree of intimacy of the target character reaches the upper limit, the control unit 101 completes this acquisition processing, and if the control unit 101 determines that the degree of intimacy of the target character does not reach the upper limit, the control unit 101 shifts the processing to S902.

In S902, the control unit 101 performs processing of providing a degree-of-intimacy point related to the target character. Through the processing, the number of accumulations 1022 of the acquired element information related to the target character is updated, and a newly provided degree-of-intimacy point is brought into the acquired state.

In S903, the control unit 101 determines whether the degree of intimacy of the target character satisfies sticker provision conditions. In the raising game of the present embodiment, the sticker provision conditions are set to cases where the degree of intimacy reaches one, three, and five, and the control unit 101 determines this step depending on whether the value of the number of accumulations 1022 of the acquired element information related to the target character updated in S902 corresponds to any one of these conditions. If the control unit 101 determines that the degree of intimacy of the target character satisfies the sticker provision condition, the control unit 101 shifts the processing to S904, and if the control unit 101 determines that the degree of intimacy does not satisfy the sticker provision condition, this acquisition processing is completed.

In S904, the control unit 101 performs processing of providing a sticker related to the target character, and completes this acquisition processing. By the processing, the grade information 1023 of the acquired element information related to the target character is updated, and a sticker of a grade corresponding to the degree of intimacy of the target character is brought into the acquisition state.

If the acquisition processing is completed in this manner, the control unit 101 shifts the facing processing to S806.

In step S807, the control unit 101 controls the display control device 104 to display a facing event on the display 110 on the basis of the result of the acquisition processing. The display related to the facing event includes displaying the acquisition performance on the display 110 as described above. Furthermore, if the display related to the facing event ends, the control unit 101 completes the facing processing.

On the other hand, if it is determined that the special AP information does not exist in the AP information acquired in S802, or if it is determined that the acquisition processing has already been executed on the same day for the special AP information in S803, the control unit 101 extracts AP information to be displayed on the selection screen in S808. As described above, in the character facing function of the present embodiment, AP information (excluding the special AP information) acquired from the top four APs 200 having high signal strength is extracted as the AP information to be displayed on the selection screen.

In S809, the control unit 101 identifies a corresponding normal character for each piece of the AP information extracted in S808. Specifically, the control unit 101, on the basis of a value obtained by performing a predetermined calculation on a value corresponding to a BSSID included in the extracted AP information, identifies friend character information including the value in the identification information 1013 from the friend character DB 122, and identifies the normal character on the basis of the friend character information.

In S810, the control unit 101 controls the display control device 104 so as to cause the display 110 to display the selection screen including an ESSID of the extracted AP information and an image suggesting the normal character identified in S808.

In step S811, the control unit 101 determines whether a selection operation of selecting an ESSID for generating a facing event has been performed. If the control unit 101 determines that the selection operation has been performed, the control unit 101 shifts the processing to S812, and if the control unit 101 determines that the selection operation has not been performed, the control unit 101 repeats the processing of this step.

In S812, the control unit 101 generates a facing event related to the normal character related to the ESSID for which the selection operation has been performed.

In S813, the control unit 101 executes the acquisition processing for the normal character related to the ESSID for which the selection operation has been performed.

If the acquisition processing is completed, the control unit 101 controls the display control device 104 to display a facing event on the display 110 on the basis of the result of the acquisition processing in S814. Furthermore, if the display related to the facing event ends, the control unit 101 completes the facing processing.

As described above, according to the game apparatus of the present embodiment, a new technique for enhancing the amusement can be provided.

### [Modification 1]

In the above-described embodiment, it has been described that the facing condition for a predetermined number of normal characters set up in advance is equalized by a value range of a solution obtained by performing a predetermined calculation on a value corresponding to a BSSID being adjusted for a normal character. However, implementation of the present invention is not limited thereto, and for example, for some of friend characters included in the normal characters, the facing condition may be limited. As one aspect, for some of the normal characters, the acquisition processing may be executed only in the case of a specific time range such as a season or a time zone.

### [Modification 2]

In the above-described embodiment, in order to facilitate understanding of the invention, the description has been given assuming that there is at most one piece of AP information including a special SSID as an ESSID in acquired AP information in the description of the facing processing, but implementation of the present invention is not limited thereto. For example, a plurality of APs 200 to which a special SSID is set may be installed at the same time, and in this case, there may be a plurality of pieces of AP information including a special SSID as an ESSID in acquired AP information. In such an aspect, after a facing event is forcibly generated for one piece of AP information related to a special character, a facing event related to another special character can be generated, but the user may stop using the character facing function without noticing the presence of corresponding AP information. Thus, after the facing event related to a special character is generated, in a case where there is another piece of AP information related to a special character for which a facing event has not been forcibly generated, a notification of this may be given, and the user may be urged to use the character facing function again. Alternatively, instead of such a notification, control may be performed such that a facing event related to another special character is forcibly generated subsequently.

### [Modification 3]

In the embodiment and the modifications described above, the description has been given assuming that a sticker of the highest grade of a special character is brought into the acquisition state by one-time execution of the acquisition processing, but implementation of the present invention is not limited thereto. In the present invention, it is sufficient that availability of a game element related to a special character is set higher than that of a normal character, and a sticker of the highest grade may be brought into the acquisition state on condition that the acquisition processing is executed twice or more for a sticker related to a special character.

### [Modification 4]

In the embodiment and the modifications described above, the description has been given assuming that a degree-of-intimacy point or a sticker is brought into the acquisition state in the acquisition processing related to a facing event until the degree of intimacy reaches the upper limit, but implementation of the present invention is not limited thereto. A game element that is brought into the acquisition state related to a facing event may further include a performance displayed due to occurrence of a facing event (including a performance that does not involve acquisition of degree-of-intimacy points or stickers) even in a case where the acquisition processing has been executed on the same day or the degree of intimacy reaches the upper limit. In this aspect, for a friend character to be faced, a game element of a display opportunity of a performance related to a facing event is provided. Note that a game element that is brought into the acquisition state in implementation of the present invention is not limited thereto, and may include other game elements related to a game executed in the game apparatus 100.

### [Modification 5]

In the embodiment and the modifications described above, the description has been given assuming that a normal character is identified on the basis of a BSSID included in AP information, and a special character is identified on the basis of an ESSID, but implementation of the present invention is not limited thereto. For example, a special character may be identifiable on the basis of a combination of a BSSID and an ESSID included in AP information.

### [Modification 6]

In the embodiment and the modifications described above, the description has been given assuming that a friend character to be faced in a facing event is identified on the basis of character string information included in AP information received from the AP 200, but implementation of the present invention is not limited thereto. The character string information for identifying a friend character may be acquired by another method, for example, by detecting a character string from a captured image.

### SUMMARY OF EMBODIMENTS

The above embodiment discloses at least the following game apparatus and program.

(1) A game apparatus that executes a game, the game apparatus including:
an acquisition unit that acquires character string information related to acquisition of a game element;
an identification unit that identifies the game element from the character string information;
a display control unit that causes a display unit to display one or more pieces of the character string information acquired by the acquisition unit in a selectable state; and
a control unit that performs control such that the game element identified from the selected character string information is brought into an acquisition state in the game on a basis of selection of one of the one or more pieces of the character string information.

(2) The game apparatus according to (1), in which
the character string information includes first character string information and second character string information, and
the identification unit identifies the game element from at least one of the first character string information and the second character string information of the character string information.

(3) The game apparatus according to (2), in which the identification unit identifies the game element from the second character string information on condition that the second character string information indicates a predetermined character string.

(4) The game apparatus according to (3) further including:
a storage unit that stores the predetermined character string; and
an update unit that updates at least one of a program and data related to operation of the game apparatus, in which
the predetermined character string is changeable on a basis of update by the update unit.

(5) The game apparatus according to (3) or (4), in which the identification unit identifies the game element from the first character string information on condition that the second character string information does not indicate the predetermined character string.

(6) The game apparatus according to any one of (3) to (5), in which the display control unit causes the display unit to display the second character string information of the one or more pieces of the character string information in a selectable state, and does not cause the display unit to display the first character string information of the one or more pieces of the character string information.

(7) The game apparatus according to (6), in which the display control unit causes the display unit to display, for each of the one or more pieces of the character string information, an image suggesting the game element identified from the first character string information of the character string information in association with the second character string information of the character string information.

(8) The game apparatus according to (6) or (7), in which the display control unit does not cause the display unit to display the second character string information indicating the predetermined character string.

(9) The game apparatus according to any one of (3) to (8) further including a management unit that manages the game element brought into an acquisition state in the game, in which
the control unit performs control such that the game element is brought into an acquisition state without depending on selection of the one or more pieces of the character string information on condition that the second character string information indicating the predetermined character string is included in the one or more pieces of the character string information and the game element identified from the second character string information is not in an acquisition state.

(10) The game apparatus according to (9), in which
the game element includes the game element of a first type and the game element of a second type, and
the identification unit identifies the game element of the first type from the first character string information and identifies the game element of the second type from the second character string information.

(11) The game apparatus according to (10), in which one game element of the second type can be identified from one type of the second character string information, and one game element of the first type can be identified from a plurality of types of the first character string information.

(12) The game apparatus according to (10) or (11), in which the number of times that the game element of the first type can be brought into an acquisition state is larger than the number of times that the game element of the second type can be brought into an acquisition state.

(13) The game apparatus according to any one of (10) to (12), in which the control unit performs control such that an identical game element of the first type is brought into an acquisition state again on condition that a time range is different from a time range in which the identical game element of the first type is most recently brought into an acquisition state.

(14) The game apparatus according to any one of (10) to (13), in which
each of the game elements includes an element of one or more grades, and
the control unit performs control such that an element of a class based on the number of times of being brought into an acquisition state is brought into an acquisition state for the game element identified from the selected character string information.

(15) The game apparatus according to (14), in which the number of grades set up for the game element is larger in the game element of the first type than in the game element of the second type.

(16) The game apparatus according to any one of (10) to (15) further including a browsing unit that causes the display unit to display a list of the game element in an acquisition state, in which
the browsing unit causes the display unit to display the game element of the first type and the game element of the second type as different lists.

(17) The game apparatus according to (16), in which the list of the game element of the first type includes the game element of the first type that is not in an acquisition state in an indistinguishable manner, and the list of the game element of the second type does not include the game element of the second type that is not in an acquisition state.

(18) The game apparatus according to (16) or (17), in which the display control unit causes the display unit to further display, for the game element selected from the list of the game element in an acquisition state, the number of times the game element has been brought into an acquisition state.

(19) The game apparatus according to (18), in which
an upper limit number of times that each of the game elements can be brought into an acquisition state is determined, and
the display control unit causes the display unit to further display, for the game element selected from the list of the game element in an acquisition state, a remaining number of times the game element can be brought into an acquisition state.

(20) The game apparatus according to any one of (10) to (19), in which the display control unit further causes the display unit to display an acquisition performance related to acquisition of the game element.

(21) The game apparatus according to (20), in which the display control unit causes the display unit to display the acquisition performance related to the game element of the second type identified from the second character string information on condition that the second character string information indicating the predetermined character string is included in the one or more pieces of the character string information.

(22) The game apparatus according to (21), in which the display control unit causes the display unit to display the acquisition performance related to the game element of the first type identified from the first character string information of the selected character string information on a basis of selection of one of the one or more pieces of the character string information.

(23) The game apparatus according to (22), in which the acquisition performance related to the game element of the first type changes in content on a basis of the number of times that the game element of the first type is brought into an acquisition state, and the acquisition performance related to the game element of the second type has a fixed content regardless of the number of times that the game element of the second type is brought into an acquisition state.

(24) The game apparatus according to (23), in which the acquisition performance related to the game element of the first type changes in at least background on a basis of the number of times the game element of the first type is brought into an acquisition state.

(25) The game apparatus according to (23) or (24), in which the acquisition performance related to the game element of the first type includes display indicating the number of times the game element of the first type is brought into an acquisition state.

(26) The game apparatus according to any one of (2) to (25) further including a communication unit that communicates with an access point, in which
the acquisition unit acquires the character string information from the access point that has communicated via the communication unit.

(27) The game apparatus according to (26), in which
the first character string information is a BSSID of the access point, and
the second character string information is an ESSID of the access point.

(28) A program for causing a computer to function as each unit of the game apparatus according to any one of (1) to (27).

### OTHER EMBODIMENTS

The invention is not limited to the above embodiment, and various modifications and changes can be made within the scope of the gist of the invention.

What is claimed is:

1. A game apparatus that executes a game, the game apparatus comprising:
an acquisition unit that acquires character string information related to acquisition of a game element;
an identification unit that identifies the game element from the character string information;
a display control unit that causes a display unit to display one or more portions of the character string information acquired by the acquisition unit in a selectable state; and
a control unit that brings the game element identified from the selected character string information into an acquisition state in the game on a basis of selection of one of the one or more portions of the character string information.

2. The game apparatus according to claim 1, wherein
the character string information includes a first character string information and a second character string information, and
the identification unit identifies the game element from at least one of the first character string information and the second character string information of the character string information.

3. The game apparatus according to claim 2, wherein
the identification unit identifies the game element from the second character string information on condition that the second character string information indicates a predetermined character string.

4. The game apparatus according to claim 3 further comprising:
a storage unit that stores the predetermined character string; and
an update unit that updates at least one of a program and data related to operation of the game apparatus, wherein
the predetermined character string is changeable based on the update by the update unit.

5. The game apparatus according to claim 3, wherein
the identification unit identifies the game element from the first character string information on condition that the second character string information does not indicate the predetermined character string.

6. The game apparatus according to claim 3, wherein
the display control unit causes the display unit to display the second character string information of the one or more portions of the character string information in a selectable state, and does not cause the display unit to display the first character string information of the one or more portions of the character string information.

7. The game apparatus according to claim 6, wherein
the display control unit causes the display unit to display, for each of the one or more portions of the character string information, an image suggesting the game element identified from the first character string information of the character string information in association with the second character string information of the character string information.

8. The game apparatus according to claim 6, wherein
the display control unit does not cause the display unit to display the second character string information indicating the predetermined character string.

9. The game apparatus according to claim 3 further comprising a management unit that manages the game element brought into an acquisition state in the game, wherein
the control unit performs control such that the game element is brought into an acquisition state without depending on selection of the one or more portions of the character string information on condition that the second character string information indicating the predetermined character string is included in the one or more portions of the character string information and the game element identified from the second character string information is not in an acquisition state.

10. The game apparatus according to claim 9, wherein
the game element includes the game element of a first type and the game element of a second type, and
the identification unit identifies the game element of the first type from the first character string information and identifies the game element of the second type from the second character string information.

11. The game apparatus according to claim 10, wherein
one game element of the second type can be identified from one type of the second character string information, and one game element of the first type can be identified from a plurality of types of the first character string information.

12. The game apparatus according to claim 10, wherein
the number of times that the game element of the first type can be brought into an acquisition state is larger than the number of times that the game element of the second type can be brought into an acquisition state.

13. The game apparatus according to claim 10, wherein
the control unit performs control such that an identical game element of the first type is brought into an acquisition state again on condition that a time range is different from a time range in which the identical game element of the first type is most recently brought into an acquisition state.

14. The game apparatus according to claim 10, wherein
each of the game elements includes an element of one or more grades, and
the control unit performs control such that an element of a class based on the number of times of being brought into an acquisition state is brought into an acquisition state for the game element identified from the selected character string information.

15. The game apparatus according to claim 14, wherein
the number of grades set up for the game element is larger in the game element of the first type than in the game element of the second type.

16. The game apparatus according to claim 10 further comprising a browsing unit that causes the display unit to display a list of the game element in an acquisition state, wherein
the browsing unit causes the display unit to display the game element of the first type and the game element of the second type as different lists.

17. The game apparatus according to claim 16, wherein
the list of the game element of the first type includes the game element of the first type that is not in an acquisition state in an indistinguishable manner, and the list of the game element of the second type does not include the game element of the second type that is not in an acquisition state.

18. The game apparatus according to claim 16, wherein
the display control unit causes the display unit to further display, for the game element selected from the list of the game element in an acquisition state, the number of times the game element has been brought into an acquisition state.

19. The game apparatus according to claim 2 further comprising a communication unit that communicates with an access point, wherein
the acquisition unit acquires the character string information from the access point that has communicated via the communication unit.

20. The game apparatus according to claim 19, wherein
the first character string information is a BSSID of the access point, and
the second character string information is an ESSID of the access point.
